(19) United States
(12) Patent Application Publication
(10) Pub. No.: US 2026/0299194 A1
(43) Pub. Date: Oct. 1, 2026

(54) OPTICAL CHIP, METHOD OF PREPARING OPTICAL CHIP, AND OPTICAL MODULE

(71) Applicant: HISENSE BROADBAND MULTIMEDIA TECHNOLOGIES CO., LTD., Qingdao (CN)

(72) Inventors: Xuejin YAN, Qingdao (CN); Jianying ZHOU, Qingdao (CN)

(21) Appl. No.: 19/327,879

(22) Filed: Sep. 12, 2025

Related U.S. Application Data
(63) Continuation of application No. PCT/CN2025/104824, filed on Jun. 27, 2025.

(30) Foreign Application Priority Data
Mar. 31, 2025 (CN) 202510398122.9
Jun. 24, 2025 (CN) 202510857087.2

(51) Int. Cl. G02B 6/12; G02B 6/13; G02B 6/134

(52) U.S. Cl. CPC G02B 6/12004; G02B 6/131; G02B 6/1347; G02B 2006/12061; G02B 2006/12078; G02B 2006/12142

(57) ABSTRACT

Provided are an optical chip, a method of preparing the optical chip, and an optical module. The optical chip includes an electrode electrically connected to a radio frequency traveling waveguide, and a ridged waveguide including a first region and a second region located at a side of the first region. The electrode is disposed above the first region and not above the second region. There are no helium ions in the first region; there are helium ions in an n++-InGaAs layer and a fourth n-InP layer or a p++-InGaAs layer and a p-InP layer in the second region; and there are no helium ions in an i-InP layer and below the i-InP layer in the second region. This facilitates stable isolation between active regions on the ridged waveguide, and a radio frequency signal injected into the ridged waveguide through the electrode can be electrically isolated between adjacent electrodes.

This disclosure is a continuation of International Application No. PCT/CN2025/104824, filed on Jun. 27, 2025, which claims priority to Chinese Patent Application No. 202510398122.9, filed with the China National Intellectual Property Administration on Mar. 31, 2025 and priority to Chinese Patent Application No. 202510857087.2, filed with the China National Intellectual Property Administration on Jun. 24, 2025. All above-mentioned applications are incorporated herein by reference in their entirety.

### FIELD OF THE INVENTION

The present disclosure relates to the field of optical communication technology, and in particular, to an optical chip, a method of preparing the optical chip, and an optical module.

### BACKGROUND OF THE INVENTION

With the development of new services and application models such as cloud computing, mobile Internet, and video, advances in optical communication technology have become increasingly important. In optical communication technology, the optical module, as one of the key devices in optical communication equipment, enables the conversion between optical and electrical signals. In the optical module, an optical chip is used to emit an optical signal carrying information. Light is modulated to generate the optical signal.

### SUMMARY OF THE INVENTION

In some embodiments, an optical chip is provided, including:
an electrode electrically connected to a radio frequency traveling waveguide;
a ridged waveguide including a first region and a second region located at a side of the first region, where the electrode is disposed above the first region, while the electrode is not disposed above the second region; the first region includes, from top to bottom, an n++-InGaAs layer, a fourth n-InP layer, an i-InP layer, an i-InGaAsP layer and a quantum well layer, and the second region includes, from top to bottom, an n++-InGaAs layer, a fourth n-InP layer, an i-InP layer, an i-InGaAsP layer and a quantum well layer; or the first region includes, from top to bottom, a p++-InGaAs layer, a p-InP layer, an i-InP layer, an i-InGaAsP layer and a quantum well layer, and the second region includes, from top to bottom, a p++-InGaAs layer, a p-InP layer, an i-InP layer, an i-InGaAsP layer and a quantum well layer;
there are no helium ions in the first region; there are helium ions in the n++-InGaAs layer and the fourth n-InP layer in the second region, or in the p++-InGaAs layer and the p-InP layer in the second region; and there are no helium ions in the i-InP layer and below the i-InP layer in the second region.

In some embodiments, a method of preparing an optical chip is provided, the method including:
forming a ridged waveguide, the ridged waveguide including a first region and a second region, where the first region is configured to arrange an electrode thereon, the second region is located at opposite ends of the first region, and the electrode is not arranged above the second region, and where the first region includes an n++-InGaAs layer, a fourth n-InP layer, an i-InP layer, an i-InGaAsP layer and a quantum well layer that are arranged from top to bottom, and the second region includes an n++-InGaAs layer, a fourth n-InP layer, an i-InP layer, an i-InGaAsP layer and a quantum well layer that are arranged from top to bottom;
covering the first region with a preset mask, and implanting helium ions into a lower part of the second region in multiple times, where there are no helium ions in the first region, there are helium ions in the p++-InGaAs layer and the p-InP layer in the second region, and there are no helium ions in the i-InP layer and below the i-InP layer in the second region; and
forming the electrode and a radio frequency traveling waveguide on a top of the first region, where the electrode is electrically connected to the radio frequency traveling waveguide.

In some embodiments, an optical module is provided, including:
a circuit board;
an optical chip that is electrically connected to the circuit board and configured to modulate and generate an optical signal, where the optical chip is the optical chip provided in the above embodiment or the optical chip prepared by the preparation method provided in the above embodiment.

### BRIEF DESCRIPTION OF THE DRAWINGS

To illustrate the technical solutions in the present disclosure more clearly, a brief introduction to the drawings used in some embodiments of the present disclosure will be provided below. Apparently, the drawings described below are merely the drawings in some embodiments of the present disclosure. Those of ordinary skill in the art can also derive other drawings from these drawings. Furthermore, the drawings described below can be regarded as schematic diagrams and are not intended to limit the actual dimensions of the products, the actual processes of the methods, or the actual timing of the signals involved in the embodiments of the present disclosure.

FIG. 1 is a partial architecture diagram of an optical communication system according to some embodiments;

FIG. 2 is a partial structural diagram of a host computer according to some embodiments;

FIG. 3 is a structural diagram of an optical module according to some embodiments;

FIG. 4 is an exploded view of an optical module according to some embodiments;

FIG. 5 is a schematic diagram of an internal structure of an optical module according to some embodiments;

FIG. 6 is a schematic structural diagram of an optical chip according to some embodiments;

FIG. 7 is a schematic structural diagram of another optical chip according to some embodiments;

FIG. 8A is a cross-sectional view of a modulator according to some embodiments;

FIG. 8B is a top view of a modulator according to some embodiments;

FIG. 9A is a first cross-sectional view of an optical chip according to some embodiments;

FIG. 9B is a second cross-sectional view of an optical chip according to some embodiments;

FIG. 9C is a third cross-sectional view of an optical chip according to some embodiments;

FIG. 10A is a first cross-sectional view of another optical chip according to some embodiments;

FIG. 10B is a second cross-sectional view of another optical chip according to some embodiments;

FIG. 11A is a first cross-sectional view of another optical chip according to some embodiments;

FIG. 11B is a second cross-sectional view of another optical chip according to some embodiments;

FIG. 11C is a third cross-sectional view of another optical chip according to some embodiments;

FIG. 12A is a first cross-sectional view of another optical chip according to some embodiments;

FIG. 12B is a second cross-sectional view of another optical chip according to some embodiments; and

FIG. 13 is a structural diagram of a hybrid integrated optical assembly according to some embodiments.

### DETAILED DESCRIPTION OF THE EMBODIMENTS

The following describes some embodiments of the present disclosure clearly and in detail with reference to the drawings. However, the described embodiments are some but not all of the embodiments of the present disclosure. All other embodiments obtained by those of ordinary skill in the art based on the embodiments provided in the present disclosure fall within the scope of protection of the present disclosure.

Unless otherwise required by the context, throughout the specification and the claims, the term “include/comprise” is interpreted as open and inclusive, meaning “including/comprising, but not limited to”; the terms “first” and “second” should not be construed as indicating or implying relative importance or indicating an upper limit on quantity; the term “a plurality of” means two or more; the term “connection” should be understood broadly, for example, “connection” may be a fixed connection, a detachable connection, or an integral connection, or may be directly connected, or indirectly connected via an intermediate medium; the term “adapted to” or “configured to” is an open and inclusive language, and does not exclude devices adapted or configured to perform additional tasks or steps; and the terms “parallel,” “vertical,” “same,” “consistent,” “flush,” etc. are not limited to absolute mathematical theoretical relationships, but also include acceptable error ranges arising in practice, as well as differences formed due to manufacturing reasons based on the same design concept.

In optical communication technology, it is necessary to establish information transmission between information processing devices. Establishing information transmission requires loading information onto light. Information transmission is achieved by the propagation of light. Here, the light loaded with information is an optical signal. Optical signals are transmitted in information transmission devices. Such transmission can reduce optical power loss. Therefore, high-speed information transmission, long-distance information transmission, and low-cost information transmission can be achieved. The signals that the information processing devices can recognize are electrical signals. The signals that the information processing devices can process are electrical signals. The information processing devices typically include an optical network unit (ONU), a gateway, a router, a switch, a mobile phone, a computer, a server, a tablet computer, a television, an optical fiber, an optical waveguide, etc.

The optical modules enable the conversion between optical signals and electrical signals from the information processing devices and the information transmission devices. For example, an optical signal input end of an optical module is connected to an optical fiber. Alternatively, an optical signal output end of an optical module is connected to an optical fiber. Alternatively, both an optical signal input end and an optical signal output end of an optical module are connected to an optical fiber. An electrical signal input end of an optical module is connected to an optical network unit. Alternatively, an electrical signal output end of an optical module is connected to an optical network unit. Alternatively, both an electrical signal input end and an electrical signal output end of an optical module are connected to an optical network unit. A first optical signal from the optical fiber is transmitted to the optical module. The optical module converts the first optical signal into a first electrical signal. The optical module transmits the first electrical signal to the optical network unit. A second electrical signal from the optical network unit is transmitted to the optical module. The optical module converts the second electrical signal into a second optical signal. The optical module transmits the second optical signal to the optical fiber. Information can be transmitted through electrical signals between a plurality of information processing devices. Therefore, at least one information processing device in the plurality of information processing devices is required to be directly connected to the optical module. It is not necessary for all information processing devices to be directly connected to the optical module. Here, the information processing device directly connected to the optical module is referred to as a host computer of the optical module. Additionally, the optical signal input end of the optical module may be referred to as an optical port. Alternatively, the optical signal output end of the optical module may be referred to as an optical port. The electrical signal input end of the optical module may be referred to as an electrical port. Alternatively, the electrical signal output end of the optical module may be referred to as an electrical port.

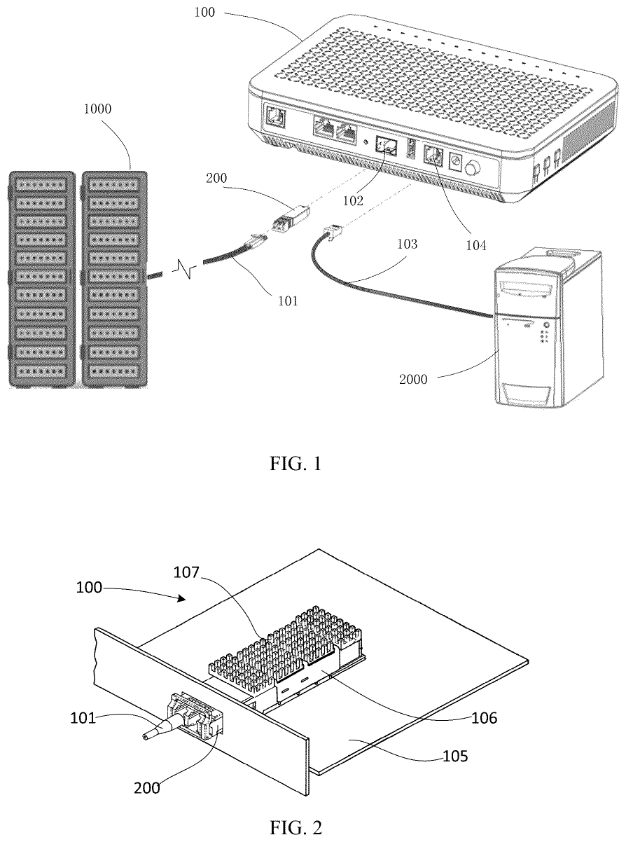

FIG. 1 is a partial structural diagram of an optical communication system according to some embodiments. As shown in FIG. 1, the optical communication system mainly includes a remote information processing device 1000, a local information processing device 2000, a host computer 100, an optical module 200, an optical fiber 101, and a network cable 103.

One end of the optical fiber 101 extends toward the remote information processing device 1000. The other end of the optical fiber 101 is connected to the optical module 200 via an optical port of the optical module 200. An optical signal can undergo total reflection in the optical fiber 101. The optical signal propagating in the total reflection direction can almost maintain its original optical power. The optical signal undergoes multiple total reflections in the optical fiber 101. An optical signal from the remote information processing device 1000 is transmitted to the optical module 200 via total reflection. Alternatively, an optical signal from the optical module 200 is transmitted to the remote information processing device 1000 via total reflection. Thus, long-distance information transmission and low-power-loss information transmission are achieved.

The optical communication system may include a single optical fiber 101. Alternatively, the optical communication system may include a plurality of optical fibers 101. The optical fiber 101 is detachably connected to the optical module 200. Alternatively, the optical fiber 101 is fixedly connected to the optical module 200. The host computer 100 is configured to provide a data signal to the optical module 200. Alternatively, the host computer 100 is configured to receive a data signal from the optical module 200. Alternatively, the host computer 100 is configured to monitor an operating status of the optical module 200. Alternatively, the host computer 100 is configured to control an operating status of the optical module 200.

The host computer 100 includes a housing. The housing is a standard rectangular cuboid, or the housing is a relatively standard rectangular cuboid. The host computer 100 includes an optical module interface 102. The optical module interface 102 is disposed on the housing. The optical module interface 102 is configured to be connected to the optical module 200. The host computer 100 is connected to the optical module 200 to establish a unidirectional electrical signal connection between the host computer 100 and the optical module 200. Alternatively, the host computer 100 is connected to the optical module 200 to establish a bidirectional electrical signal connection between the host computer 100 and the optical module 200.

The host computer 100 further includes an external electrical interface. The external electrical interface can be connected to an electrical signal network. For example, the external electrical interface includes a universal serial bus (USB) interface. Alternatively, the external electrical interface includes a network cable interface 104. The network cable interface 104 is configured to be connected to the network cable 103. The connection to the network cable 103 establishes a unidirectional electrical signal connection between the host computer 100 and the network cable 103. Alternatively, the connection to the network cable 103 establishes a bidirectional electrical signal connection between the host computer 100 and the network cable 103. One end of the network cable 103 is connected to the local information processing device 2000. The other end of the network cable 103 is connected to the host computer 100. The network cable 103 establishes an electrical signal connection between the local information processing device 2000 and the host computer 100. For example, the local information processing device 2000 emits a third electrical signal. The third electrical signal is transmitted to the host computer 100 via the network cable 103. The host computer 100 generates a second electrical signal based on the third electrical signal. The second electrical signal from the host computer 100 is transmitted to the optical module 200. The optical module 200 converts the second electrical signal into a second optical signal. The optical module 200 transmits the second optical signal to the optical fiber 101. The second optical signal is transmitted in the optical fiber 101. The second optical signal is transmitted to the remote information processing device 1000. For example, a first optical signal from the remote information processing device 1000 is transmitted via the optical fiber 101. A first optical signal from the optical fiber 101 is transmitted to the optical module 200. The optical module 200 converts the first optical signal into a first electrical signal. The optical module 200 transmits the first electrical signal to the host computer 100. The host computer 100 generates a fourth electrical signal based on the first electrical signal. The host computer 100 transmits the fourth electrical signal to the local information processing device 2000. It should be noted that the optical module is a tool to achieve the conversion between optical signals and electrical signals. During the conversion between the optical signals and the electrical signals, the information remains unchanged, the encoding method and the decoding method for the information may vary.

The host computer 100 includes an optical network unit. The host computer 100 further includes an optical line terminal (OLT). Alternatively, the host computer 100 further includes an optical network terminal (ONT). Alternatively, the host computer 100 further includes a data center server, etc.

FIG. 2 is a partial structural diagram of a host computer according to some embodiments. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105. The PCB 105 is disposed in the housing. The host computer 100 further includes a cage 106. The cage 106 is disposed on the surface of the PCB 105. The host computer 100 further includes a heat sink 107. The heat sink 107 is disposed on the cage 106. The host computer 100 further includes an electrical connector. The electrical connector is disposed inside the cage 106. The electrical connector is configured to be connected to the electrical port of the optical module 200. The heat sink 107 is provided with protruding structures. The protruding structures are configured to increase the heat dissipation area. The protruding structures are, for example, fins.

The optical module 200 is inserted into the cage 106 of the host computer 100. The optical module 200 is fixed with the cage 106. Heat generated by the optical module 200 is conducted to the cage 106. The heat is dissipated through the heat sink 107. After the optical module 200 is inserted into the cage 106, the electrical port of the optical module 200 is connected to the electrical connector inside the cage 106. The connection establishes a bidirectional electrical signal connection between the optical module 200 and the host computer 100. In addition, the optical port of the optical module 200 is connected to the optical fiber 101. The connection establishes a bidirectional optical signal connection between the optical module 200 and the optical fiber 101.

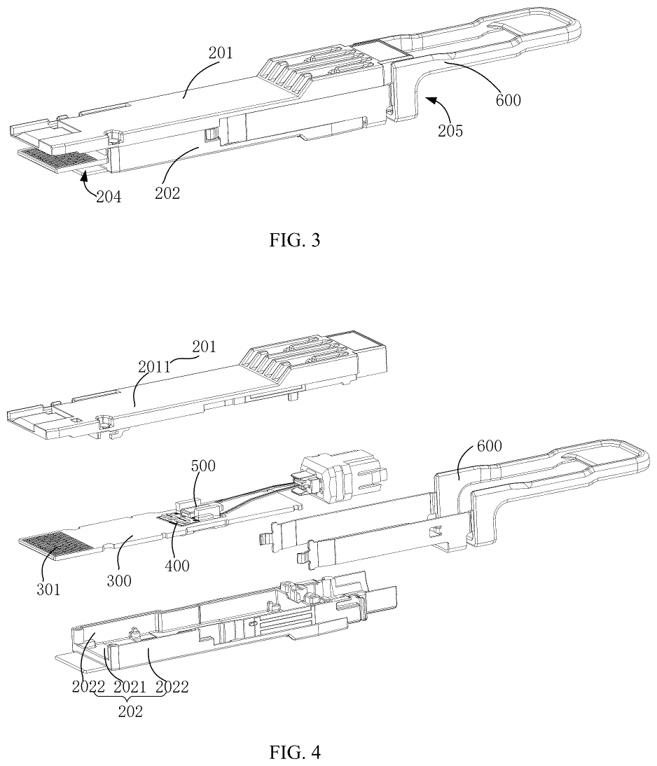

FIG. 3 is a structural diagram of an optical module according to some embodiments. FIG. 4 is an exploded view of an optical module according to some embodiments. As shown in FIG. 3 and FIG. 4, the optical module 200 includes a shell. The optical module 200 includes a circuit board 300. The circuit board 300 is disposed in the shell. The optical module 200 includes an optical chip 400. The optical module 200 includes a light source 500. By way of example, the optical chip 400 is electrically connected to the circuit board 300. The light source 500 is electrically connected to the circuit board 300. A light output end of the light source 500 is optically coupled to the optical chip 400. In some embodiments, the light output end of the light source 500 is coupled to the optical chip 400 via the optical fiber.

The shell includes an upper shell 201 and a lower shell 202. The upper shell 201 covers the lower shell 202, thereby forming the shell with an opening 204 and an opening 205. The shell is a standard rectangular cuboid, or the shell is a relatively standard rectangular cuboid.

In some embodiments, the lower shell 202 includes a base plate 2021. The lower shell 202 includes two lower side plates 2022. The two lower side plates 2022 are located at two sides of the base plate 2021. The two lower side plates 2022 are arranged perpendicular to the base plate 2021. The upper shell 201 includes a cover plate 2011. The cover plate 2011 covers the two lower side plates 2022 of the lower shell 202, thereby forming the shell.

In some embodiments, the lower shell 202 includes a base plate 2021. The lower shell 202 includes two lower side plates 2022. The two lower side plates 2022 are located at two sides of the base plate 2021. The two lower side plates 2022 are arranged perpendicular to the base plate 2021. The upper shell 201 includes a cover plate 2011. The upper shell 201 includes two upper side plates. The two upper side plates are located at two sides of the cover plate 2011. The two upper side plates are arranged perpendicular to the cover plate 2011. The two upper side plates are combined with the two lower side plates 2022, thereby ensuring that the upper shell 201 covers the lower shell 202.

The direction of a connecting line between the opening 204 and the opening 205 may be consistent with the length direction of the optical module 200. Alternatively, the direction of a connecting line between the opening 204 and the opening 205 may be inconsistent with the length direction of the optical module 200. For example, the opening 204 is located at an end of the optical module 200 (the left end in FIG. 3), and the opening 205 is also located at an end of the optical module 200 (the right end in FIG. 3). Alternatively, the opening 204 is located at an end of the optical module 200, and the opening 205 is located at a side of the optical module 200. The opening 204 is an electrical port. A gold finger 301 of the circuit board 300 extends out from the opening 204. The gold finger 301 is inserted into the electrical connector of the host computer 100. The opening 205 is an optical port. The opening 205 is configured to be connected to the external optical fiber 101. The connection to the optical fiber 101 enables the optical fiber 101 to be connected to the optical chip 400 in the optical module 200.

The assembly method of combining the upper shell 201 with the lower shell 202 is adopted. This assembly method facilitates the installation of the circuit board 300, the optical modulation chip, and the light source into the shell. The upper shell 201 and the lower shell 202 can provide packaging protection for the above-mentioned devices. In addition, during assembly of the circuit board 300, it is convenient for the deployment of a positioning component of the circuit board 300, a heat dissipation component of the circuit board 300, and an electromagnetic shielding component of the circuit board 300. During assembly of the optical chip 400, it is convenient for the deployment of a positioning component of the optical chip 400, a heat dissipation component of the optical chip 400, and an electromagnetic shielding component of the optical chip 400. During assembly of the light source 500, it is convenient for the deployment of a positioning component of the light source 500, a heat dissipation component of the light source 500, and an electromagnetic shielding component of the light source 500. Such deployment is conducive to automated production.

In some embodiments, the upper shell 201 is made of a metal material, and the lower shell 202 is made of a metal material. The metal material is beneficial for electromagnetic shielding and heat dissipation.

In some embodiments, the optical module 200 further includes an unlocking component 600. The unlocking component 600 is located outside the shell of the optical module 200. The unlocking component 600 is configured to achieve a fixed connection between the optical module 200 and the host computer. Alternatively, the unlocking component 600 is configured to release the fixed connection between the optical module 200 and the host computer.

For example, the unlocking component 600 is located outside the two lower side plates 2022 of the lower shell 202. The unlocking component 600 includes an engaging component. The engaging component matches the cage 106 of the host computer 100. When the optical module 200 is inserted into the cage 106, the optical module 200 is fixed in the cage 106 via the engaging component of the unlocking component 600. When the unlocking component 600 is pulled, the engaging component of the unlocking component 600 moves accordingly. The movement changes the connection relationship between the engaging component and the host computer. The change in the connection relationship releases the fixation of the optical module 200 to the host computer. Releasing the fixation allows the optical module 200 to be withdrawn from the cage 106.

The circuit board 300 includes circuit traces, electronic components, and chips. The electronic components and the chips are connected according to the circuit design via the circuit traces. The connection implements a power supply function, an electrical signal transmission function, and a grounding function. The electronic components may include, for example, capacitors, resistors, transistors, and metal-oxide-semiconductor field-effect transistors (MOSFET). The chips may include, for example, microcontroller units (MCU), laser driver chips, transimpedance amplifiers (TIA), limiting amplifiers (LA), clock and data recovery (CDR) chips, power management chips, and digital signal processing (DSP) chips.

The circuit board 300 is generally a rigid circuit board. The rigid circuit board is made of a relatively hard material. As a result, the rigid circuit board can provide support. For example, the rigid circuit board can stably support the above-mentioned electronic components. The rigid circuit board can stably support the above-mentioned chips. The rigid circuit board can also be inserted into the electrical connector in the cage 106 of the host computer 100.

The circuit board 300 further includes a gold finger 301. The gold finger 301 is formed on the end surface of the circuit board 300. The gold finger 301 is composed of a plurality of mutually independent pins. The circuit board 300 is inserted into the cage 106. The gold finger 301 is electrically connected to the electrical connector in the cage 106. The gold finger 301 may be disposed only on the surface of one side of the circuit board 300 (e.g., the upper surface shown in FIG. 4). Alternatively, the gold finger 301 may be disposed on the surfaces of upper and lower sides of the circuit board 300. When the gold finger is disposed on the surfaces of upper and lower sides of the circuit board, a greater number of pins can be provided. Providing more pins can meet the needs of occasions requiring a large number of pins. The gold finger 301 is configured to establish an electrical connection with the host computer. The electrical connection achieves power supply, grounding, two-wire inter-integrated circuit (I2C) signal transmission, and data signal transmission. Certainly, flexible circuit boards are also used in some optical modules. Flexible circuit boards are generally used in conjunction with rigid circuit boards. Flexible circuit boards serve as a supplement to rigid circuit boards.

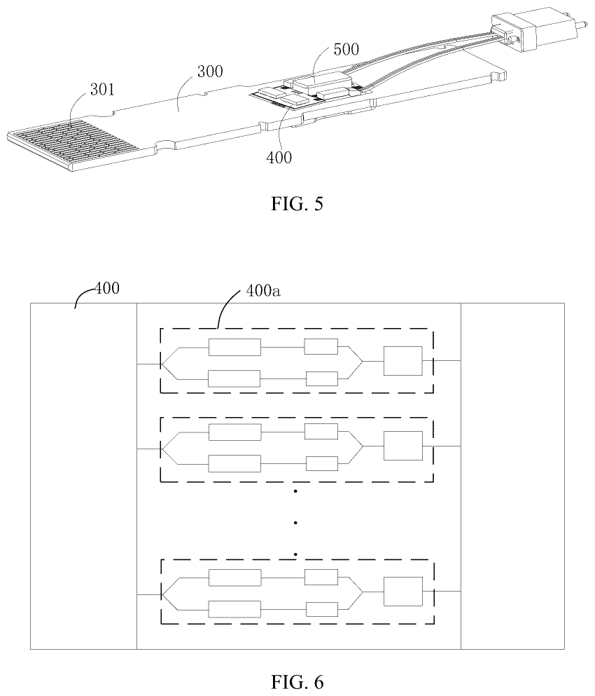

FIG. 5 is a schematic diagram of an internal structure of an optical module according to some embodiments of the present disclosure. As shown in FIG. 5, in some embodiments, the light source 500 is disposed at a side edge of the optical chip 400. The light source 500 emits light from a side surface. The emitted light from the light source 500 is coupled into the optical chip 400. The light source 500 serves as an external light source for the optical chip 400. The light emitted by the light source 500 enters the optical chip 400. The light source 500 may be a laser box. A laser is packaged inside the laser box. The laser emits light to generate a laser beam. The light source 500 is configured to provide emitted laser light to the optical chip 400. The laser light has a good single-wavelength characteristic and an excellent wavelength-tuning characteristic. The laser light has become the preferred light source for the optical module, and the preferred light source for optical fiber transmission. Other types of light, such as LED light, are generally not used in common optical communication systems. Even if such light sources are used in special optical communication systems, the characteristics of such light sources differ greatly from those of the laser light. Even if such light sources are used in special optical communication systems, chip components of such light sources differ greatly from those of the laser light. The differences result in significant technical differences between optical modules using laser light and those using other light sources. Those skilled in the art generally do not consider that these two types of optical modules can provide technical inspiration to each other.

When the non-data-carrying light emitted by the light source 500 enters the optical chip 400, the optical chip 400 performs phase modulation on the light to load the electrical signal onto it, so as to obtain data-carrying light, namely, an optical emission signal, thereby achieving emission of the optical signal.

In some embodiments, the optical chip 400 may be a silicon photonic chip. That is, the optical chip 400 is formed by packaging with a silicon material. The silicon photonic chip includes a Mach-Zehnder modulator (MZM). A silicon photonic phase modulator is integrated inside the MZM. The silicon photonic phase modulator is configured to achieve modulation and demodulation of the optical signal. Since the silicon photonic chip is easy to etch, other functional devices can be integrated inside the silicon photonic chip. For example, an optical splitter, an optical combiner, a frequency mixer, and an optical detector can be integrated inside the silicon photonic chip. The integration can achieve more functions. A silicon-based optical modulator is integrated inside the silicon photonic chip. The silicon-based optical modulator utilizes the plasma dispersion effect of the silicon material. The plasma dispersion effect is used to regulate and control an optical field. Regulation and control achieve modulation of the optical signal. However, basic characteristics of the silicon material result in low modulation efficiency, high capacitance, limited bandwidth, and high optical loss for the silicon-based optical modulator.

In some embodiments, the optical chip 400 may be a hybrid InP/Si photonic chip. The hybrid InP/Si photonic chip is formed by hybrid packaging with an InP material and a silicon material. That is, the optical chip 400 may be formed by hybrid packaging with the InP material and the silicon material. In the hybrid packaging, the InP material is used to provide high-speed modulation, and the Si material is used to provide a highly integrated silicon photonic circuit, The hybrid packaging endows the optical chip 400 with the high-speed modulation characteristic of the InP material, and enables the optical chip 400 to meet the requirements for high baud rate modulation. The hybrid packaging fully leverages the characteristics of the Si material and the InP material. In this case, the hybrid InP/Si optical chip can combine the performance of the InP material with the performance of the Si material. The combination endows the optical chip 400 with excellent performance, and facilitates increasing the bandwidth of the optical chip 400. The hybrid InP/Si optical chip includes an MZM. The MZM is formed by integration of materials such as an InP material.

Certainly, in some embodiments, the light source 500 may be integrated into the optical chip 400. The light source 500 and the optical chip 400 are integrated and packaged.

FIG. 6 is a schematic structural diagram of an optical chip according to some embodiments. As shown in FIG. 6, in some embodiments, the optical chip 400 includes a modulator 400a. The modulator 400a may be formed by hybrid packaging with an InP material and a silicon material. The modulator 400a may modulate an optical signal based on a quantum well confined Stark effect. The modulation is achieved by controlling variation of an applied electric field. The variation in the applied electric field causes a change in carriers. The change in the carriers achieves a change in a refractive index. The change in the refractive index enables modulation of the optical signal. The modulator formed by hybrid packaging with the InP material and the silicon material has a high modulation rate.

In some embodiments, a plurality of modulators 400a may be disposed in the optical chip 400. The plurality of modulators 400a modulate and output multiple optical signals. By way of example, four modulators 400a may be disposed in the optical chip 400. The four modulators 400a output four optical signals. Alternatively, eight modulators 400a may be disposed in the optical chip 400. The eight modulators 400a output eight optical signals.

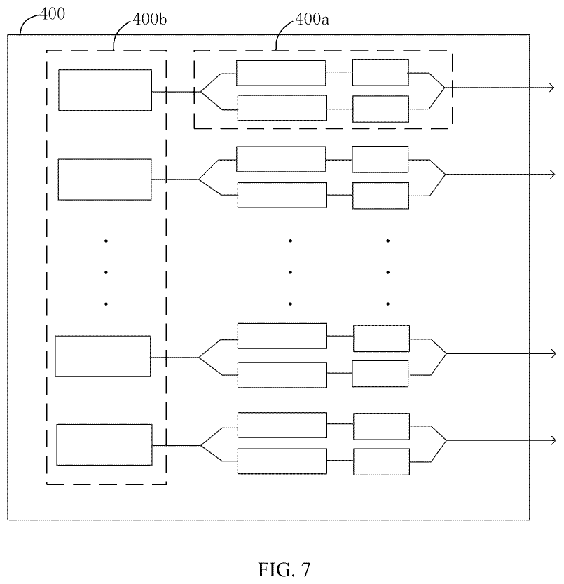

FIG. 7 is a schematic structural diagram of another optical chip according to some embodiments. As shown in FIG. 7, in some embodiments, a light-emitting region 400b is integrated in the optical chip 400. The light-emitting region 400b is located at an input end of the modulator 400a. The light-emitting region 400b can provide a light source for the modulator 400a. By way of example, the light-emitting region 400b can generate a light beam. The light beam is optically connected to the modulator 400a via an optical waveguide. The optical waveguide transmits the light beam generated by the laser to the modulator 400a. Integrating the light-emitting region and the modulator inside the optical chip 400 facilitates improving the integration level of the optical chip. The integration can reduce the local power density and the thermal stress. Reducing the thermal stress improves the reliability of the hybrid integrated optical chip. Improving the reliability makes the optical chip 400 applicable to multi-channel transmission. When the light-emitting region 400b and the modulator 400a are integrated in the optical chip 400, the size of the device in the optical module can be reduced.

In some embodiments, the light-emitting region 400b may be grown from an InP material. The light-emitting region 400b may include a p-InP layer, an active quantum well layer, an n-InP layer, a grating layer, etc.

In some embodiments, a Si waveguide may be disposed between the light-emitting region 400b and the modulator 400a. Alternatively, an InP waveguide or the like may be disposed between the light-emitting region 400b and the modulator 400a. The Si waveguide has low optical loss.

In some embodiments, a beam of light can be generated in the light-emitting region 400b. When a plurality of modulators 400a are formed in the optical chip 400, the light-emitting region 400b generates a beam of light. The optical chip 400 may be integrated with an optical splitter. The optical splitter splits a beam of light. The split beams are transmitted to the plurality of modulators 400a.

In some embodiments, a plurality of modulators 400a are formed in the optical chip 400. The light-emitting region 400b can generate multiple beams of light. The multiple beams of light are transmitted to the corresponding modulators 400a. By way of example, if the light-emitting region 400b generates eight beams of light, eight modulators 400a are formed in the optical chip 400. Alternatively, if the light-emitting region 400b generates sixteen beams of light, sixteen modulators 400a are formed in the optical chip 400.

In some embodiments, the light-emitting region 400b may be grown from an InP material.

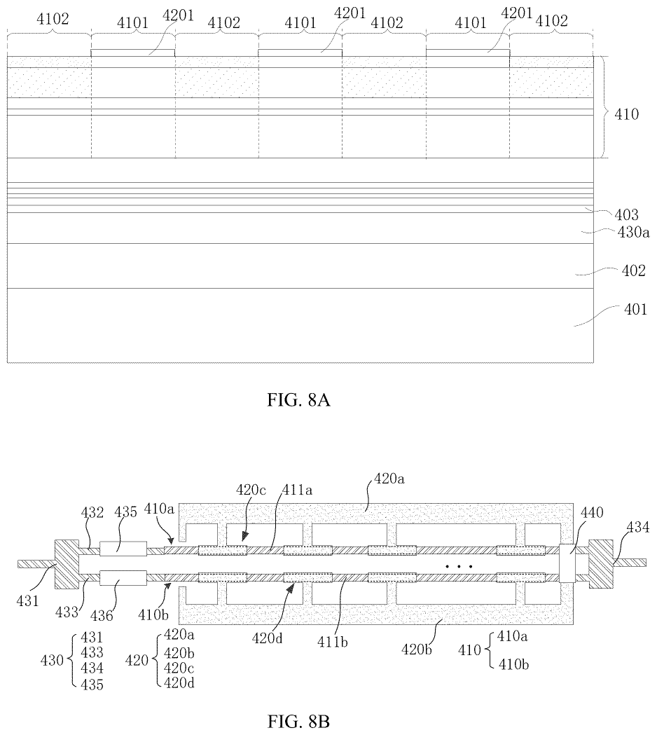

FIG. 8A is a cross-sectional view of a modulator according to some embodiments. FIG. 8A shows a partial cross-sectional structure along an extension direction of a ridged waveguide. As shown in FIG. 8A, in some embodiments, the modulator 400a includes a ridged waveguide 410. The ridged waveguide 410 extends along the left-right direction as shown in FIG. 8A. The ridged waveguide 410 includes a first region 4101 and a second region 4102. The second region 4102 is located at opposite ends of the first region 4101. Adjacent first regions 4101 are connected via the second region 4102. An electrode 4201 is disposed on a top of the first region 4101. No electrode is disposed on a top of the second region 4102. The ridged waveguide 410 may be formed from a multilayer InP-based material. The electrode 4201 may be made of a highly conductive metal material. For example, the electrode 4201 may be made of gold. Alternatively, the electrode 4201 may be made of silver. Alternatively, the electrode 4201 may be made of copper. The metal material enables good electrical contact.

In some embodiments, the first region 4101 may include an n++-InGaAs layer. The n++-InGaAs layer is located at an upper side. The first region 4101 may include a fourth n-InP layer. The fourth n-InP layer is located below the n++-InGaAs layer. The first region 4101 may include an i-InP layer. The i-InP layer is located below the fourth n-InP layer. The first region 4101 may include an i-InGaAsP layer. The i-InGaAsP layer is located below the i-InP layer. The first region 4101 may include a quantum well layer. The quantum well layer is located below the i-InGaAsP layer. Certainly, in some embodiments, the first region 4101 may further include a p++-InGaAs layer. The p++-InGaAs layer is located at an upper side. The first region 4101 may further include a p-InP layer. The p-InP layer is located below the p++-InGaAs layer. The first region 4101 may further include an i-InP layer. The i-InP layer is located below the p-InP layer. The first region 4101 may further include an i-InGaAsP layer. The i-InGaAsP layer is located below the i-InP layer. The first region 4101 may further include a quantum well layer. The quantum well layer is located below the i-InGaAsP layer.

In some embodiments, the second region 4102 may include an n++-InGaAs layer. The n++-InGaAs layer is located at an upper side. The second region 4102 may include a fourth n-InP layer. The fourth n-InP layer is located below the n++-InGaAs layer. The second region 4102 may include an i-InP layer. The i-InP layer is located below the fourth n-InP layer. The second region 4102 may include an i-InGaAsP layer. The i-InGaAsP layer is located below the i-InP layer. The second region 4102 may include a quantum well layer. The quantum well layer is located below the i-InGaAsP layer. Alternatively, the second region 4102 may include a p++-InGaAs layer. The p++-InGaAs layer is located at an uppermost side. The second region 4102 may include a p-InP layer. The p-InP layer is located below the p++-InGaAs layer. The second region 4102 may include an i-InP layer. The i-InP layer is located below the p-InP layer. The second region 4102 may include an i-InGaAsP layer. The i-InGaAsP layer is located below the i-InP layer. The second region 4102 may include a quantum well layer. The quantum well layer is located below the i-InGaAsP layer. Certainly, in some embodiments, the second region 4102 may include a fourth n-InP layer. The fourth n-InP layer is located at an upper side. The second region 4102 may include an i-InP layer. The i-InP layer is located below the fourth n-InP layer. The second region 4102 may include an i-InGaAsP layer. The i-InGaAsP layer is located below the i-InP layer. The second region 4102 may include a quantum well layer. The quantum well layer is located below the i-InGaAsP layer. Alternatively, the second region 4102 may include a p-InP layer. The p-InP layer is located at an uppermost side. The second region 4102 may include an i-InP layer. The i-InP layer is located below the p-InP layer. The second region 4102 may include an i-InGaAsP layer. The i-InGaAsP layer is located below the i-InP layer. The second region 4102 may include a quantum well layer. The quantum well layer is located below the i-InGaAsP layer.

In some embodiments, a radio frequency traveling waveguide 420 is disposed at one side of the top of the ridged waveguide 410. The radio frequency traveling waveguide 420 is electrically connected to the electrode 4201. During operation of the optical chip, a radio frequency signal is loaded onto the radio frequency traveling waveguide 420. The radio frequency signal is transmitted to the electrode 4201 via the radio frequency traveling waveguide 420. The radio frequency signal is injected into the ridged waveguide 410 through the electrode 4201, and the quantum well layer generates an optical signal.

To ensure the high bandwidth requirement of the optical chip, a high-resistance characteristic is required between the first region 4101 and the second region 4102 before the radio frequency signal is injected into the i-InP layer. Alternatively, a good electrical insulation characteristic is required between the first region 4101 and the second region 4102 before the radio frequency signal is injected into the i-InP layer. Therefore, in some embodiments, there is He⁺ in the layer above the i-InP layer in the second region 4102. There is no He⁺ in the i-InP layer in the second region 4102. There is no He +in the layer below the i-InP layer in the second region 4102. This arrangement can increase the impedance of the layer above the i-InP layer in the second region 4102. There is no He +in the first region 4101. The absence of He⁺ minimizes the lateral movement of the radio frequency signal injected through the electrode 4201 in the layer above the i-InP layer. The radio frequency signal can flow laterally in the i-InP layer. The radio frequency signal can flow laterally in the layer below the i-InP layer. By way of example, there may be He⁺ in the n++-InGaAs layer in the second region 4102. Alternatively, there may be He⁺ in the fourth n-InP layer in the second region 4102. Alternatively, there may be He⁺ in the p++-InGaAs layer in the second region 4102. Alternatively, there may be He⁺ in the p-InP layer in the second region 4102. Alternatively, there may be He⁺ in the fourth n-InP layer in the second region 4102. Alternatively, there may be He⁺ in the p-InP layer in the second region 4102.

He⁺ is implanted into the n++-InGaAs layer of the second region 4102. There is He⁺ in the n++-InGaAs layer of the second region 4102 after implantation. He⁺ is implanted into the fourth n-InP layer of the second region 4102. There is He⁺ in the n++-InGaAs layer and the fourth n-InP layer of the second region 4102 after implantation. He⁺ enters holes in the n++-InGaAs layer, and He⁺ enters holes in the fourth n-InP layer, such that the defects in the n++-InGaAs layer of the second region 4102 and the defects in the fourth n-InP layer of the second region 4102 are modified, thereby increasing the impedance of the n++-InGaAs layer of the second region 4102, and increasing the impedance of the fourth n-InP layer of the second region 4102. Compared with the n++-InGaAs layer in the first region 4101 without He⁺, the n++-InGaAs layer of the second region 4102 exhibits a high-resistance characteristic. Compared with the fourth n-InP layer in the first region 4101 without He⁺, the fourth n-InP layer of the second region 4102 exhibits a high-resistance characteristic. Correspondingly, He⁺ is implanted into the p++-InGaAs layer of the second region 4102, such that there is He⁺ in the p++-InGaAs layer of the second region 4102. He⁺ is implanted into the p-InP layer of the second region 4102, such that there is He⁺ in the p++-InGaAs layer and the p-InP layer of the second region 4102. He⁺ enters holes in the p++-InGaAs layer, and He⁺ enters holes in the p-InP layer, such that the defects in the p++-InGaAs layer of the second region 4102 are modified, and the defects in the p-InP layer of the second region 4102 are modified, thereby increasing the impedance of the p++-InGaAs layer of the second region 4102, and increasing the impedance of the p-InP layer of the second region 4102. Compared with the p++-InGaAs layer in the first region 4101 without He⁺, the p++-InGaAs layer of the second region 4102 exhibits a high-resistance characteristic. Compared with the p-InP layer in the first region 4101 without He⁺, the p++-InGaAs layer and p-InP layer of the second region 4102 exhibit high-resistance characteristics.

FIG. 8B is a top view of a modulator according to some embodiments. As shown in FIG. 8B, in some embodiments, the modulator 400a may include a first ridged waveguide 410a. The modulator 400a may include a second ridged waveguide 410b. A trench is formed between the first ridged waveguide 410a and the second ridged waveguide 410b. The trench separates the first ridged waveguide 410a and the second ridged waveguide 410b. The first ridged waveguide 410a may be formed from a multilayer InP-based material. The second ridged waveguide 410b may be formed from a multilayer InP-based material.

In some embodiments, the first ridged waveguide 410a may include a first region 4101. The first ridged waveguide 410a may include a second region 4102.

In some embodiments, the second ridged waveguide 410b may include a first region 4101. The second ridged waveguide 410b may include a second region 4102.

In some embodiments, the modulator 400a includes a radio frequency traveling waveguide 420. The radio frequency traveling waveguide 420 is located at a side edge above the ridged waveguide 410. The radio frequency traveling waveguide 420 includes a first radio frequency traveling waveguide 420a and a second radio frequency traveling waveguide 420b. The radio frequency traveling waveguide 420 includes a first electrode group 420c and a second electrode group 420d. The first electrode group 420c is located on a top of the first ridged waveguide 410a. The second electrode group 420d is located on a top of the second ridged waveguide 410b. The first radio frequency traveling waveguide 420a extends along an extension direction of the first ridged waveguide 410a. The second radio frequency traveling waveguide 420b extends along an extension direction of the second ridged waveguide 410b. There is a gap between the first radio frequency traveling waveguide 420a and the second radio frequency traveling waveguide 420b. The first electrode group 420c is located in the gap. The second electrode group 420d is located in the gap. The first electrode group 420c is located in the first region 4101 of the first ridged waveguide 410a. The second electrode group 420d is located in the first region 4101 of the second ridged waveguide 410b.

In some embodiments, one end of the first radio frequency traveling waveguide 420a may be provided with a radio frequency pad. One end of the second radio frequency traveling waveguide 420b may be provided with a radio frequency pad. The radio frequency pad is configured to facilitate an electrical connection between the first radio frequency traveling waveguide 420a and a driver. The radio frequency pad is configured to facilitate an electrical connection between the second radio frequency traveling waveguide 420b and the driver.

In some embodiments, the modulator 400a may include a matching resistor 440. The other end of the first radio frequency traveling waveguide 420a may be electrically connected to the matching resistor 440. The other end of the second radio frequency traveling waveguide 420b may be electrically connected to the matching resistor 440. The matching resistor 440 may include a plurality of resistors. The first radio frequency traveling waveguide 420a is electrically connected to the matching resistor 440. The second radio frequency traveling waveguide 420b is electrically connected to the matching resistor 440. This electrical connection optimizes impedance matching of the first radio frequency traveling waveguide 420a. This electrical connection optimizes impedance matching of the second radio frequency traveling waveguide 420b. This optimization reduces reflection loss. This optimization improves the transmission efficiency of the radio frequency signal.

In some embodiments, the first electrode group 420c includes a plurality of first electrodes. The plurality of first electrodes in the first electrode group 420c are arranged at intervals. There is a gap between adjacent first electrodes. The second electrode group 420d includes a plurality of second electrodes. The plurality of second electrodes in the second electrode group 420d are arranged at intervals. There is a gap between adjacent second electrodes. The first electrodes in the first electrode group 420c are arranged opposite to the second electrodes in the second electrode group 420d. This arrangement causes the first electrodes in the first electrode group 420c and the second electrodes in the second electrode group 420d to form capacitively loaded electrode pairs. By way of example, the first electrodes in the first electrode group 420c and the second electrodes in the second electrode group 420d form multiple electrode pairs. For example, ten electrode pairs are formed. Alternatively, twelve electrode pairs are formed. Alternatively, twenty-four electrode pairs are formed. The first electrodes in the first electrode group 420c are made of a highly conductive metal material. For example, the first electrode is made of gold. Alternatively, the first electrode is made of silver. Alternatively, the first electrode is made of copper. The second electrodes in the second electrode group 420d are made of a highly conductive metal material. For example, the second electrode is made of gold. Alternatively, the second electrode is made of silver. Alternatively, the second electrode is made of copper. The metal material ensures a good electrical contact.

The first ridged waveguide 410a below the first electrode group 420c is an active region of the first ridged waveguide 410a. The first electrodes divide the active region on the first ridged waveguide 410a into a plurality of active segments. The second ridged waveguide 410b below the second electrode group 420d is an active region of the second ridged waveguide 410b. The second electrodes divide the active region of the second ridged waveguide 410b into a plurality of active segments.

In some embodiments, the first radio frequency traveling waveguide 420a is located at a side edge of the first electrode group 420c. The first radio frequency traveling waveguide 420a is electrically connected to the electrodes in the first electrode group 420c. By way of example, an inner side of the first radio frequency traveling waveguide 420a is electrically connected to the electrodes in the first electrode group 420c.

In some embodiments, the second radio frequency traveling waveguide 420b is located at a side edge of the second electrode group 420d. The second radio frequency traveling waveguide 420b is electrically connected to the electrodes in the second electrode group 420d. By way of example, an inner side of the second radio frequency traveling waveguide 420b is electrically connected to the electrodes in the second electrode group 420d.

In some embodiments, the second region 4102 on the first ridged waveguide 410a is implanted with He⁺. After implantation, a first isolation portion 411a can be formed. No electrode is disposed on a top of the first isolation portion 411a. The first isolation portion 411a is located below the gap between adjacent electrodes in the first electrode group 420c. After He⁺ implantation in the second region 4102 on the first ridged waveguide 410a, a plurality of first isolation portions 411a can be formed. The first isolation portion 411a has an electrical insulation characteristic. Alternatively, the first isolation portion 411a has a high-resistance characteristic. The electrical insulation characteristic/the high-resistance characteristic enables electrical isolation between adjacent electrodes in the first electrode group 420c. The electrical isolation facilitates improving electrical isolation between active segments on the first ridged waveguide 410a.

In some embodiments, the second region 4102 on the second ridged waveguide 410b is implanted with He⁺. After implantation, a second isolation portion 411b can be formed. No electrode is disposed on a top of the second isolation portion 411b. The second isolation portion 411b is located below the gap between adjacent electrodes in the second electrode group 420d. After He⁺ implantation in the second region 4102 on the second ridged waveguide 410b, a plurality of second isolation portions 411b can be formed. The second isolation portion 411b has an electrical insulation characteristic. Alternatively, the second isolation portion 411b has a high-resistance characteristic. This characteristic enables electrical isolation between adjacent electrodes in the second electrode group 420d. The electrical isolation facilitates improving electrical isolation between active segments on the first ridged waveguide 410a. The second isolation portion 411b implanted with He⁺ can maintain a good high-resistance characteristic even after high-temperature treatment, for example, after annealing at 420° C.

In some embodiments, a dose of He⁺ implanted into the second region 4102 is 1×10¹⁴ cm⁻² to 9×10¹⁴ cm⁻². For example, the implantation dose is 2×10¹⁴ cm⁻². The first isolation portion 411a implanted with He⁺ can maintain a good high-resistance characteristic even after high-temperature treatment, for example, after annealing at 420° C.

In some embodiments, the modulator 400a may include a Si waveguide 430a. The Si waveguide 430a is located below the ridged waveguide 410. One end of the Si waveguide 430a extends beyond one end of the ridged waveguide 410. The other end of the Si waveguide 430a extends beyond the other end of the ridged waveguide 410.

In some embodiments, the Si waveguide 430a includes an optical input end 431, a first Si waveguide 432, a second Si waveguide 433, and an optical output end 434. The optical input end 431 is located at one end below the ridged waveguide 410. The optical output end 434 is located at the other end below the ridged waveguide 410. One end of the first Si waveguide 432 is connected to the optical input end 431. The other end of the first Si waveguide 432 is connected to the optical output end 434. The first Si waveguide 432 extends from one end below the first ridged waveguide 410a. The first Si waveguide 432 extends to the other end of the first ridged waveguide 410a. One end of the second Si waveguide 433 is connected to the optical input end 431. The other end of the second Si waveguide 433 is connected to the optical output end 434. The second Si waveguide 433 extends from one end below the second ridged waveguide 410b. The second Si waveguide 433 extends to the other end of the second ridged waveguide 410b. The optical input end 431 is configured to couple the light beam to the first Si waveguide 432. The optical input end 431 is configured to couple the light beam to the second Si waveguide 433. The optical output end 434 is configured to output the optical signal modulated by the modulator 400a.

In some embodiments, one end of the optical input end 431 may extend into the light-emitting region 400b. The light beam generated by the light-emitting region 400b is coupled to the optical input end 431.

In some embodiments, the modulator 400a may include a first heater 435. The modulator 400a may include a second heater 436. The first heater 435 may be disposed on the first Si waveguide 432. The second heater 436 may be disposed on the second Si waveguide 433.

In some embodiments, the first heater 435 may be located at a side edge of one end of the first radio frequency traveling waveguide 420a. The second heater 436 may be located at a side edge of one end of the second radio frequency traveling waveguide 420b. This positional arrangement facilitates a compact structure for the modulator 400a.

The modulator 400a in the embodiments of the present disclosure is an InP-based MZM modulator. The modulator 400a is a linear electro-optic modulator. The modulator 400a exhibits a linear electro-optic modulation effect. Based on the linear electro-optic modulation effect, the optical chip 400 in the present disclosure has high modulation efficiency and a high bit rate. The optical chip 400 in the embodiments of the present disclosure can achieve higher-order pulse amplitude modulation (PAM) at a lower modulation bandwidth under the same modulation rate. A chirp parameter of the modulator 400a is optimized by adjusting operating parameters of the modulator 400a. This optimization reduces the impact caused by a fiber dispersion effect. Reducing the impact makes the optical chip 400 more applicable to long-distance transmission. The modulator 400a in the embodiments of the present disclosure is more applicable to multi-channel transmission. The modulator 400a is more applicable to long-distance transmission. Meanwhile, the modulator 400a can achieve a high bit rate and higher-order PAM.

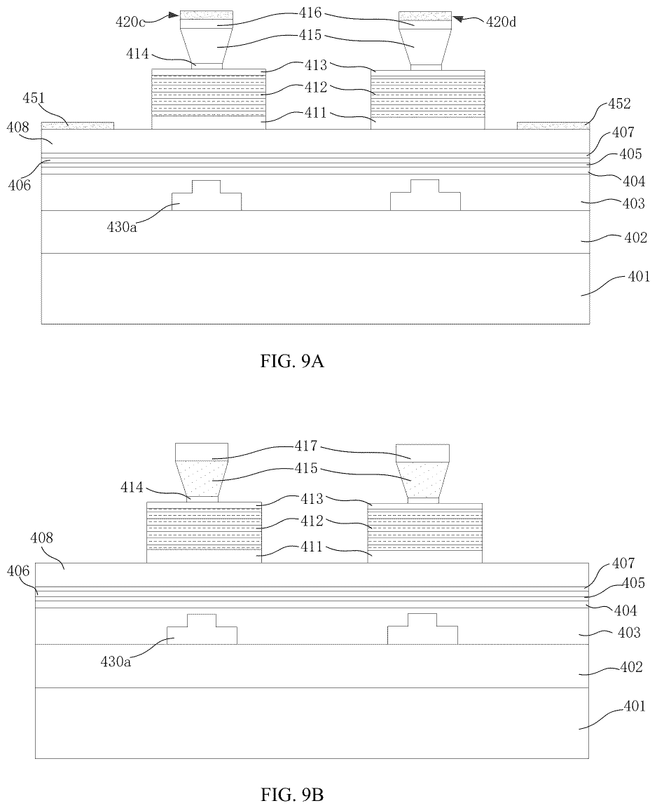

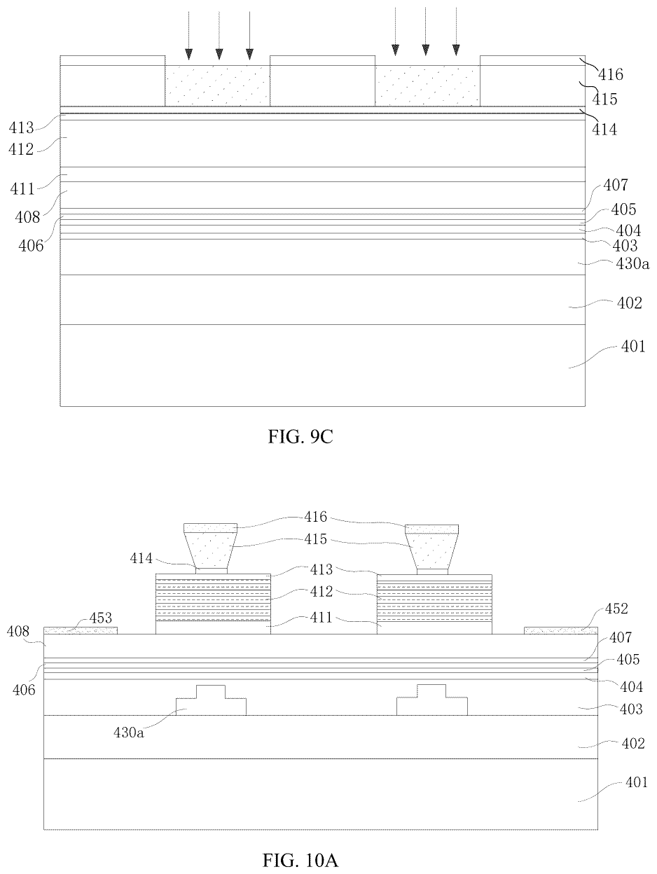

FIG. 9A is a first cross-sectional view of an optical chip according to some embodiments. FIG. 9B is a second cross-sectional view of an optical chip according to some embodiments. FIG. 9C is a third cross-sectional view of an optical chip according to some embodiments. FIG. 9A to FIG. 9C show the structures of a modulator part in an optical chip. FIG. 9A is a cross-sectional view at a first region of an optical chip. FIG. 9B is a cross-sectional view at a second region of an optical chip. FIG. 9C is a cross-sectional view at a first ridged waveguide in an optical chip. As shown in FIGS. 9A to 9C, the modulator 400a is an MZM modulator of a nipn epitaxial structure.

In some embodiments, the optical chip 400 may include a substrate layer 401. The substrate layer 401 may be epitaxially grown from an Si material.

In some embodiments, the optical chip 400 may include an intermediate layer 402. The intermediate layer 402 is located above the substrate layer 401. The intermediate layer 402 may be epitaxially grown from an SiO2 material.

In some embodiments, the optical chip 400 may include a cladding layer 403. The cladding layer 403 is located above the intermediate layer 402. The Si waveguide 430a is disposed in the cladding layer 403. The cladding layer 403 may be epitaxially grown from an SiO2 material.

In some embodiments, the optical chip 400 may include a first n-InP layer 404. The first n-InP layer 404 may be located above the cladding layer 403. The first n-InP layer 404 may be epitaxially grown from an n-type InP material.

In some embodiments, the optical chip 400 may include a first n-InGaAsP layer 405. The first n-InGaAsP layer 405 may be located above the first n-InP layer 404. The first n-InGaAsP layer 405 may be epitaxially grown from an n-type InGaAsP material.

In some embodiments, the optical chip 400 may include a second n-InP layer 406. The second n-InP layer 406 may be located above the first n-InGaAsP layer 405. The second n-InP layer 406 may be epitaxially grown from an n-type InP material.

In some embodiments, the optical chip 400 may include a second n-InGaAsP layer 407. The second n-InGaAsP layer 407 may be located above the second n-InP layer 406. The second n-InGaAsP layer 407 may be epitaxially grown from an n-type InGaAsP material.

In some embodiments, the optical chip 400 may include a third n-InP layer 408. The third n-InP layer 408 may be located above the second n-InGaAsP layer 407. The third n-InP layer 408 may be epitaxially grown from an n-type InP material.

In some embodiments, the ridged waveguide 410 may include an i-p-n-InAlAs layer 411. The i-p-n-InAlAs layer 411 is located above the third n-InP layer 408. The i-p-n-InAlAs layer 411 may include an n-InAlAs layer. The n-InAlAs layer is located at the lower side. The i-p-n-InAlAs layer 411 may include a p-InAlAs layer. The p-InAlAs layer is located above the n-InAlAs layer. The i-p-n-InAlAs layer 411 may include an i-InAlAs layer. The i-InAlAs layer is located above the p-InAlAs layer. The n-InAlAs layer may be epitaxially grown from an n-type InAlAs material. The p-InAlAs layer may be epitaxially grown from a p-type InAlAs material. The i-InAlAs layer may be epitaxially grown from an InAlAs material.

In some embodiments, the ridged waveguide 410 includes a quantum well layer 412. The quantum well layer 412 is located above the i-p-n-InAlAs layer 411. The quantum well layer 412 may be a multilayer well epitaxially grown from a quantum well material.

In some embodiments, the ridged waveguide 410 may include an i-InGaAsP layer 413. The i-InGaAsP layer 413 is located above the quantum well layer 412. The i-InGaAsP layer 413 may be epitaxially grown from an i-type InGaAsP material.

In some embodiments, the ridged waveguide 410 may include an i-InP layer 414. The i-InP layer 414 is located above the i-InGaAsP layer 413. The i-InP layer 414 may be epitaxially grown from an i-type InP material.

In some embodiments, the ridged waveguide 410 may include a fourth n-InP layer 415. The fourth n-InP layer 415 is located above the i-InP layer 414. The fourth n-InP layer 415 may be epitaxially grown from an n-type InP material.

In some embodiments, the ridged waveguide 410 may include an n++-InGaAs layer 416. The n++-InGaAs layer 416 is located above the fourth n-InP layer 415. The n++-InGaAs layer 416 is located below the first electrode group 420c. Alternatively, the n++-InGaAs layer 416 is located below the second electrode group 420d. The n++-InGaAs layer 416 serves as an electrical contact layer between the electrode and the fourth n-InP layer 415. The n++-InGaAs layer 416 may be epitaxially grown from an n-type InGaAs material. The n-InGaAs layer 416 is configured to improve the electrical contact performance between the electrode and the fourth n-InP layer 415, thereby optimizing the performance of the modulator 400a.

In some embodiments, a doping concentration of the n++-InGaAs layer 416 may be higher than that of the fourth n-InP layer 415. The high doping concentration facilitates enhancing the electrical contact performance.

In some embodiments, the electrodes in the first electrode group 420c on the n++-InGaAs layer 416 are n-electrodes. The electrodes in the second electrode group 420d on the n++-InGaAs layer 416 are n-electrodes. The n-electrode may be made of gold. Alternatively, the n-electrode may be made of platinum. The metal material forms a good electrical contact with the n++-InGaAs layer 416. Good contact facilitates effective optical signal transmission and modulation by the optical chip 400.

In some embodiments, there is He⁺ in the fourth n-InP layer 415 of the second region 4102 of the first ridged waveguide 410a. There is He⁺ in the fourth n-InP layer 415 of the second region 4102 of the second ridged waveguide 410b. The implantation depth of He⁺ is located at a bottom of the fourth n-InP layer 415. The implantation depth of He⁺ is located above the i-p-n-InAlAs layer 411, such that He⁺ is implanted and stopped at the bottom of the fourth n-InP layer 415. There is no He⁺ in the i-InP layer 414 after implantation. The implantation dose of He⁺ is 1×10¹⁴ cm⁻² to 9×10¹⁴ cm⁻². For example, the implantation dose is 2×10¹⁴ cm⁻². Implanting He⁺ into the fourth n-InP layer 415 can meet the thickness requirement of the n-InP layer. The ion implantation energy required for implantation is moderate. By way of example, when the thickness of the fourth n-InP layer 415 to be implanted is 1,700 nm, the implantation energy of He⁺ is about 400 keV. The fourth n-InP layer 415 implanted with He⁺ can maintain a good high-resistance characteristic even after high-temperature treatment, for example, after annealing at 420° C.

In some embodiments, the optical chip 400 may include a first P-electrode 451. The optical chip 400 may include a second P-electrode 452. The first P-electrode 451 is disposed on the third n-InP layer 408. The second P-electrode 452 is disposed on the third n-InP layer 408. The first P-electrode 451 may be located at one side of the ridged waveguide 410. The second P-electrode 452 may be located at the other side of the ridged waveguide 410. The first P-electrode 451 and the n-electrode in the first electrode group 420c form a PN junction. The second P-electrode 452 and the n-electrode in the second electrode group 420d form a PN junction.

The first P-electrode 451 is made of a highly conductive metal material. For example, the first P-electrode 451 is made of gold. Alternatively, the first P-electrode 451 is made of silver. Alternatively, the first P-electrode 451 is made of copper. The second P-electrode 452 is made of a highly conductive metal material. For example, the second P-electrode 452 is made of gold. Alternatively, the second P-electrode 452 is made of silver. Alternatively, the second P-electrode 452 is made of copper. The metal material ensures a good electrical contact. Good contact facilitates improving current injection efficiency and reducing capacitive coupling between the electrodes. During operation of the optical chip 400, when a current is injected into the PN junction through the first P-electrode 451, carriers in the i-InP layer 414 are excited. The excitation facilitates signal modulation. When a current is injected into the PN junction through the second P-electrode 452, carriers in the i-InP layer 414 are excited. The excitation facilitates signal modulation.

In some embodiments, the ridged waveguide 410 may include a passivation layer 417. The passivation layer 417 is located above the first isolation portion 411a and above the second isolation portion 411b. The passivation layer 417 covers an upper side of the fourth n-InP layer 415 implanted with He⁺. The passivation layer 417 may be epitaxially grown from an SiO2 material. The passivation layer 417 may also cover the outer side of the ridged waveguide 410. The passivation layer 417 may cover the third n-InP layer 408, protects the top of the optical chip 400, and makes the top of the optical chip 400 flat.

In some embodiments, an i-p-n-InAlAs layer 411 is formed above the third n-InP layer 408. A quantum well layer 412 is formed above the third n-InP layer 408. An i-InGaAsP layer 413 is formed above the third n-InP layer 408. An i-InP layer 414 is formed above the third n-InP layer 408. A fourth n-InP layer 415 is formed above the third n-InP layer 408. An n++-InGaAs layer 416 is formed above the third n-InP layer 408. The i-p-n-InAlAs layer 411, the quantum well layer 412, the i-InGaAsP layer 413, the i-InP layer 414, the fourth n-InP layer 415 and the n++-InGaAs layer 416 form a ridged waveguide layer. The ridged waveguide layer is etched to form a first ridged waveguide 410a and a second ridged waveguide 410b.

In some embodiments, a mask is used to cover a region outside the second region 4102 of the first ridged waveguide 410a. A mask is used to cover a region outside the second region 4102 of the second ridged waveguide 410b. The n++-InGaAs layer 416 above the fourth n-InP layer 415 is etched away. By way of example, the n++-InGaAs layer 416 above the fourth n-InP layer 415 can be removed by means of wet etching. He⁺ is implanted into the fourth n-InP layer 415 by means of ion implantation. The implanted He⁺ can reach the fourth n-InP layer 415 and does not reach the i-InP layer 414. In this case, there is no He⁺ in the i-InP layer 414, there is He⁺ only in the fourth n-InP layer 415 above the fourth n-InP layer 415 in the second region 4102 of the first ridged waveguide 410a, and there is He⁺ only in the fourth n-InP layer 415 above the fourth n-InP layer 415 in the second region 4102 of the second ridged waveguide 410b.

In some embodiments, after He⁺ is implanted into the fourth n-InP layer 415, a passivation layer 417 is formed above the fourth n-InP layer 415 implanted with He⁺.

In some embodiments, a passivation layer 417 is formed at a side edge of the first ridged waveguide 410a. A passivation layer 417 is formed at a side edge of the second ridged waveguide 410b. A first radio frequency traveling waveguide 420a is formed above the passivation layer 417. A second radio frequency traveling waveguide 420b is formed above the passivation layer 417. A first electrode group 420c is formed above the n++-InGaAs layer 416 in the first ridged waveguide 410a. A second electrode group 420d is formed above the n++-InGaAs layer 416 in the second ridged waveguide 410b. The first electrode in the first electrode group 420c is connected to the first radio frequency traveling waveguide 420a. The second electrode in the second electrode group 420d is connected to the second radio frequency traveling waveguide 420b.

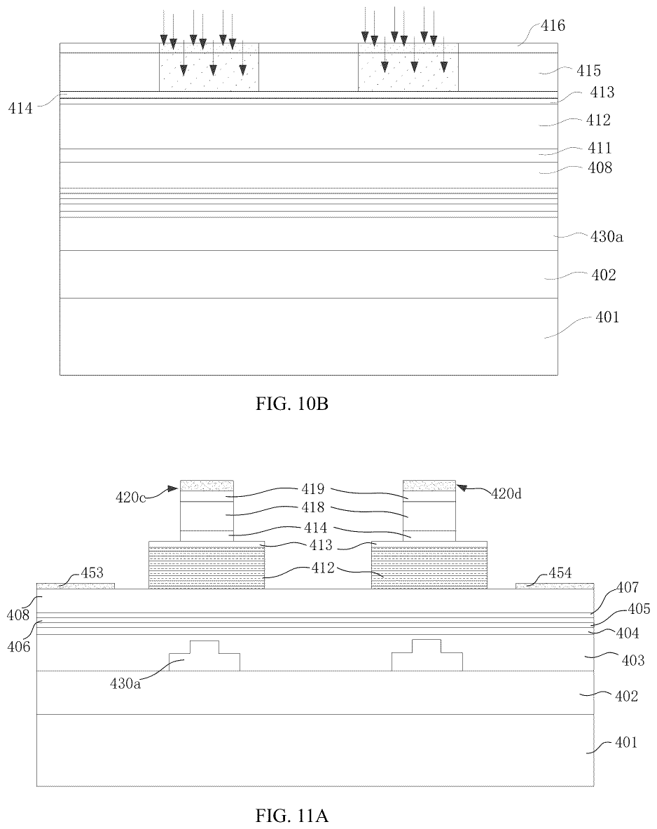

FIG. 10A is a first cross-sectional view of another optical chip according to some embodiments. FIG. 10B is a second cross-sectional view of another optical chip according to some embodiments. FIG. 10A and FIG. 10B show the structures of a modulator part in another optical chip. FIG. 10A is a cross-sectional view of an isolation portion of an optical chip. FIG. 10B is a cross-sectional view at a first ridged waveguide in an optical chip. As shown in FIG. 10A and FIG. 10B, the modulator 400a is an MZM modulator of a nipn epitaxial structure.

In some embodiments, the second region 4102 of the first ridged waveguide 410a may include an n++-InGaAs layer 416 and a fourth n-InP layer 415. The n++-InGaAs layer 416 above the fourth n-InP layer 415 is not etched away. He⁺ is implanted into the n++-InGaAs layer 416 and the fourth n-InP layer 415 of the second region 4102 of the first ridged waveguide 410a. There is no He⁺ in the i-InP layer 414 below the fourth n-InP layer 415. In an embodiment, He⁺ can be implanted into the n++-InGaAs layer 416 by means of ion implantation. He⁺ can be implanted into the fourth n-InP layer 415 by means of ion implantation. For example, He⁺ can be implanted into the n++-InGaAs layer 416 by means of secondary plasma implantation. He⁺ is implanted into the fourth n-InP layer 415 by means of secondary plasma implantation. Alternatively, He⁺ is implanted into the n++-InGaAs layer 416 by means of tertiary plasma implantation. He⁺ is implanted into the fourth n-InP layer 415 by means of tertiary plasma implantation.

In some embodiments, the second region 4102 of the second ridged waveguide 410b may include an n++-InGaAs layer 416 and a fourth n-InP layer 415. The n++-InGaAs layer 416 above the fourth n-InP layer 415 is not etched away. He⁺ is implanted into the n++-InGaAs layer 416 of the second region 4102 of the second ridged waveguide 410b. He⁺ is implanted into the fourth n-InP layer 415 of the second region 4102 of the second ridged waveguide 410b. There is no He⁺ in the i-InP layer 414 below the fourth n-InP layer 415. In an embodiment, He⁺ can be implanted into the n++-InGaAs layer 416 by means of ion implantation. He⁺ can be implanted into the fourth n-InP layer 415 by means of ion implantation into the n++-InGaAs layer. For example, He⁺ is implanted into the n++-InGaAs layer 416 by means of secondary plasma implantation. He⁺ is implanted into the fourth n-InP layer 415 by means of secondary plasma implantation. Alternatively, He⁺ is implanted into the n++-InGaAs layer 416 by means of tertiary plasma implantation. He⁺ is implanted into the fourth n-InP layer 415 by means of tertiary plasma implantation.

In some embodiments, a preset mask is used to cover the first region on a top of the first ridged waveguide 410a. A preset mask is used to cover the first region on a top of the second ridged waveguide 410b. He⁺ is implanted into the second region 4102 of the first ridged waveguide 410a in multiple times. He⁺ is implanted into the second region 4102 of the second ridged waveguide 410b in multiple times. After such implantation, there is He⁺ in the n++-InGaAs layer 416 of the second region 4102 of the first ridged waveguide 410a, there is He⁺ in the n++-InGaAs layer and the fourth n-InP layer 415 of the second region 4102 of the first ridged waveguide 410a, there is He⁺ in the n++-InGaAs layer 416 of the second region 4102 of the second ridged waveguide 410b, there is He⁺ in the fourth n-InP layer 415 of the second region 4102 of the second ridged waveguide 410b, there is no He⁺ in the i-InP layer 414, and there is no He⁺ below the i-InP layer 414.

In some embodiments, He⁺ is implanted for a first time. Such implantation causes He⁺ to be implanted and stopped at a bottom of the n++-InGaAs layer 416 below and outside a preset region. He⁺ is implanted for a second time. The secondary implantation causes He⁺ to be implanted through a contact portion between the n++-InGaAs layer 416 and the fourth n-InP layer 415 below and outside the preset region. He⁺ is implanted for a third time. The tertiary implantation causes He⁺ to be implanted and stopped at the bottom of the fourth n-InP layer 415 below and outside the preset region.

During the primary He⁺ implantation, the doping concentration of the n++-InGaAs layer 416 is high. The implantation dose of He⁺ is greater than 2×10¹⁵ cm⁻², for example, greater than 3×¹⁵ cm⁻². During the secondary He⁺ implantation, the doping concentration in the contact layer between the n++-InGaAs layer 416 and the fourth n-InP layer 415 is lower than that of the n++-InGaAs layer 416. The implantation dose of He⁺ is 2×10¹⁴ cm⁻² to 5×10¹⁵ cm⁻², for example, 3×¹⁴ cm⁻². The doping concentration of the fourth n-InP layer 415 is relatively low. The implantation dose of He⁺ is less than 2×10¹⁴ cm⁻², for example, less than 1.5×10¹⁴ cm⁻².

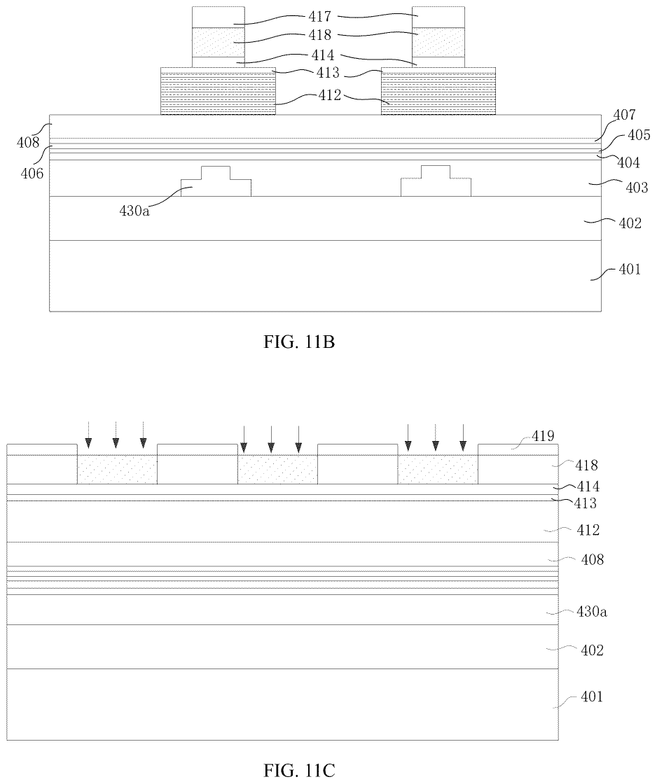

FIG. 11A is a first cross-sectional view of another optical chip according to some embodiments. FIG. 11B is a second cross-sectional view of another optical chip according to some embodiments. FIG. 11C is a third cross-sectional view of another optical chip according to some embodiments. FIG. 11A is a cross-sectional view at an electrode of an optical chip. FIG. 11B is a cross-sectional view at an isolation portion of an optical chip. FIG. 11C is a cross-sectional view at a first ridged waveguide in an optical chip. FIG. 11A to FIG. 11C show the structures of a modulator part in an optical chip. As shown in FIGS. 11A to 11C, the modulator 400a may be an MZM modulator of a pin epitaxial structure. The MZM modulator of the pin epitaxial structure has a different structure from the MZM modulator of the nipn epitaxial structure. The MZM modulator of the pin epitaxial structure also has a similar structure to the MZM modulator of the nipn epitaxial structure.

In some embodiments, the quantum well layer 412 is located above the third n-InP layer 408. The i-InP layer 414 is located above the quantum well layer 412.

In some embodiments, the ridged waveguide 410 may include a p-InP layer 418. The p-InP layer 418 is located above the i-InP layer 414. The p-InP layer 418 may be epitaxially grown from a p-type InP material.

In some embodiments, the ridged waveguide 410 may include a p++-InGaAs layer 419. The p++-InGaAs layer 419 is a p++-InGaAs layer located above the p-InP layer 418. The p++-InGaAs layer 419 is located below the first electrode group 420c. Alternatively, the p++-InGaAs layer 419 is located below the second electrode group 420d. The p++-InGaAs layer 419 serves as an electrical contact layer between the electrode and the p-InP layer 418. The p++-InGaAs layer 419 may be epitaxially grown from a p++-type InGaAs material.

In some embodiments, the electrodes in the first electrode group 420c on the p++-InGaAs layer 419 are P-electrodes. The electrodes in the second electrode group 420d on the p++-InGaAs layer 419 are P-electrodes. The P-electrode may be made of gold. Alternatively, the P-electrode may be made of platinum. The metal material exhibits a good ohmic contact.

In some embodiments, He⁺ is implanted into the p-InP layer 418 of the second region 4102 of the first ridged waveguide 410a. He⁺ is implanted into the p-InP layer 418 in the second isolation portion 411b. The implantation depth of He⁺ is located at a bottom of the p-InP layer 418. The implantation depth of He⁺ is located above the i-InP layer 414. Such implantation causes He⁺ to be stopped at the bottom of the p-InP layer 418. After such implantation, there is no He⁺ in the i-InP layer 414. The implantation dose of He⁺ is 1×10¹⁴ cm⁻² to 9×10¹⁴ cm⁻². For example, the implantation dose is 2×10¹⁴ cm⁻². Implanting He⁺ into the p-InP layer 418 can meet the thickness requirement of the p-InP layer. The ion implantation energy required for implantation is moderate. By way of example, the p-InP layer 418 implanted with He⁺ can maintain a good high-resistance characteristic even after high-temperature treatment, for example, after annealing at 420° C.

In some embodiments, the optical chip 400 may include a first n-electrode 453 and a second n-electrode 454. The first n-electrode 453 is disposed on the third n-InP layer 408. The second n-electrode 454 is disposed on the third n-InP layer 408. The first n-electrode 453 may be located at one side of the ridged waveguide 410. The second n-electrode 454 may be located at the other side of the ridged waveguide 410. The first n-electrode 453 and the P-electrode in the first electrode group 420c form a PN junction. The second n-electrode 454 and the P-electrode in the second electrode group 420d form a PN junction.

The first n-electrode 453 may be made of a highly conductive metal material. For example, the first n-electrode 453 is made of gold. Alternatively, the first n-electrode 453 is made of silver. Alternatively, the first n-electrode 453 is made of copper. The second n-electrode 454 may be made of a highly conductive metal material. For example, the second n-electrode 454 is made of gold. Alternatively, the second n-electrode 454 is made of silver. Alternatively, the second n-electrode 454 is made of copper. The metal material ensures a good electrical contact. Good contact facilitates improving current injection efficiency and reducing capacitive coupling between the electrodes. During operation of the optical chip 400, when a current is injected into the PN junction through the first n-electrode 453, carriers in the i-InP layer 414 are excited. When a current is injected into the PN junction through the second n-electrode 454, carriers in the i-InP layer 414 are excited. The carrier excitation facilitates signal modulation.

In some embodiments, a passivation layer 417 covers an upper side of the p-InP layer 418 implanted with He⁺.

In some embodiments, a quantum well layer 412 is formed above the third n-InP layer 408. An i-InGaAsP layer 413 is formed above the third n-InP layer 408. An i-InP layer 414 is formed above the third n-InP layer 408. A p-InP layer 418 is formed above the third n-InP layer 408. A p++-InGaAs layer 419 is formed above the third n-InP layer 408. The quantum well layer 412, the i-InGaAsP layer 413, the i-InP layer 414, the p-InP layer 418, and the p++-InGaAs layer 419 form a ridged waveguide layer. The ridged waveguide layer is etched to form a first ridged waveguide 410a and a second ridged waveguide 410b.

In some embodiments, a mask is used to cover a region outside the second region 4102 of the first ridged waveguide 410a. A mask is used to cover a region outside the second region 4102 of the second ridged waveguide 410b. The p++-InGaAs layer 419 above the p-InP layer 418 is etched away. By way of example, the p++-InGaAs layer 419 above the p-InP layer 418 may be etched away by means of wet etching. He⁺ is implanted into the p-InP layer 418 by means of ion implantation. The implanted He⁺ can reach the p-InP layer 418 and does not reach the i-InP layer 414. After implantation, there is no He⁺ in the i-InP layer 414, there is only the p-InP layer 418 above the i-InP layer 414 in the second region 4102 of the first ridged waveguide 410a, and there is only the p-InP layer 418 above the i-InP layer 414 in the second region 4102 of the second ridged waveguide 410b. There is He⁺ in the p-InP layer 418.

In some embodiments, after He⁺ is implanted into the p-InP layer 418, a passivation layer 417 is formed above the p-InP layer 418 implanted with He⁺.

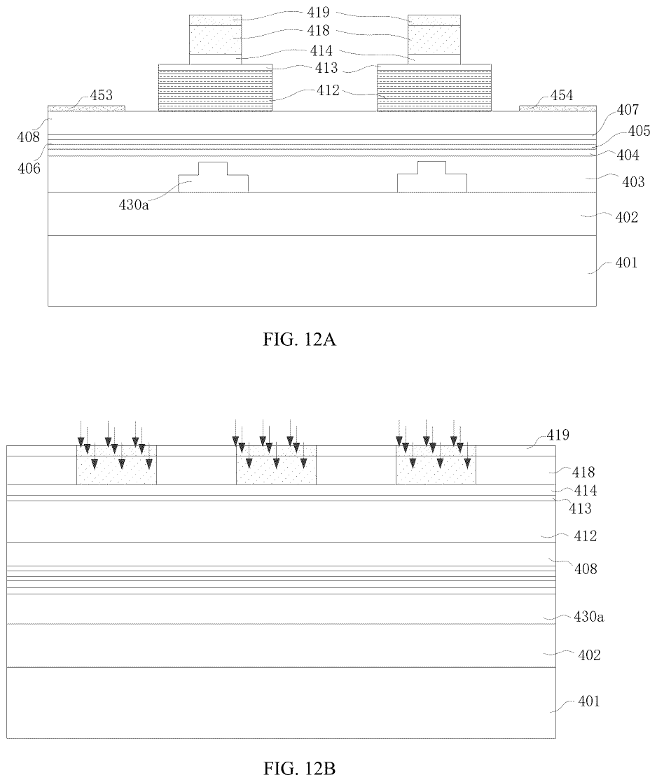

FIG. 12A is a first cross-sectional view of another optical chip according to some embodiments. FIG. 12B is a second cross-sectional view of another optical chip according to some embodiments. FIG. 12A and FIG. 12B show the structures of a modulator part in another optical chip. FIG. 12A is a cross-sectional view of an isolation portion of an optical chip. FIG. 12B is a cross-sectional view at a first ridged waveguide in an optical chip. As shown in FIG. 12A and FIG. 12B, the modulator 400a may be an MZM modulator of a pin epitaxial structure.

In some embodiments, the second region 4102 of the first ridged waveguide 410a may include a p++-InGaAs layer 419. The second region 4102 of the first ridged waveguide 410a may include a p-InP layer 418. The p++-InGaAs layer 419 above the p-InP layer 418 is not etched away. He⁺ is implanted into the p++-InGaAs layer 419 of the second region 4102 of the first ridged waveguide 410a. He⁺ is implanted into the p-InP layer 418 of the second region 4102 of the first ridged waveguide 410a. There is no He⁺ in the i-InP layer 414 below the p-InP layer 418. In an embodiment, He⁺ may be implanted into the p++-InGaAs layer 419 by means of ion implantation. He⁺ may be implanted into the p-InP layer 418 by means of ion implantation. For example, He⁺ is implanted into the p++-InGaAs layer 419 by means of secondary plasma implantation. He⁺ is implanted into the p-InP layer 418 by means of secondary plasma implantation. Alternatively, He⁺is implanted into the p++-InGaAs layer 419 by means of tertiary plasma implantation. He⁺ is implanted into the p-InP layer 418 by means of tertiary plasma implantation.

In some embodiments, the second region 4102 of the second ridged waveguide 410b may include a p++-InGaAs layer 419. The second region 4102 of the second ridged waveguide 410b may include a p-InP layer 418. The p++-InGaAs layer 419 above the p-InP layer 418 is not etched away. He⁺ is implanted into the p++-InGaAs layer 419 of the second region 4102 of the second ridged waveguide 410b. He⁺ is implanted into the p-InP layer 418 of the second region 4102 of the second ridged waveguide 410b. There is no He⁺ in the i-InP layer 414 below the p-InP layer 418. In an embodiment, He⁺ may be implanted into the p++-InGaAs layer 419 by means of ion implantation. He⁺ may be implanted into the p++-InGaAs layer and the p-InP layer 418 by means of ion implantation. For example, He⁺ is implanted into the p++-InGaAs layer 419 by means of secondary plasma implantation. He⁺ is implanted into the p-InP layer 418 by means of secondary plasma implantation. Alternatively, He⁺ is implanted into the p++-InGaAs layer 419 by means of tertiary plasma implantation. He⁺ is implanted into the p-InP layer 418 by means of tertiary plasma implantation.

In some embodiments, He⁺ is implanted into the p++-InGaAs layer 419 of the second region 4102 of the first ridged waveguide 410a. He⁺ is implanted into the p-InP layer 418 of the second region 4102 of the first ridged waveguide 410a. He⁺ is implanted into the p++-InGaAs layer 419 of the second region 4102 of the second ridged waveguide 410b. He⁺ is implanted into the p-InP layer 418 of the second region 4102 of the second ridged waveguide 410b. The implantation is performed in multiple times. There is no He⁺ in the i-InP layer 414 below the second region 4102 after implantation.

In some embodiments, He⁺ is implanted for a first time. Such implantation causes He⁺ to be implanted and stopped at a bottom of the p++-InGaAs layer 419 in the second region 4102. He⁺ is implanted for a second time. The secondary implantation causes He⁺ to be implanted through a contact portion between the p++-InGaAs layer 419 and the p-InP layer 418 in the second region 4102. He⁺ is implanted for a third time. The tertiary implantation causes He⁺ to be implanted and stopped at the bottom of the p-InP layer 418 in the second region 4102. After such implantation, there is no He⁺ in the i-InP layer 414.

During the primary He⁺ implantation, the doping concentration of the p++-InGaAs layer 419 is high. The implantation dose of He⁺ is greater than 2×10¹⁵ cm⁻², for example, greater than 3×¹⁵ cm⁻². During the secondary He⁺ implantation, the doping concentration in the contact layer between the p++-InGaAs layer 419 and the p-InP layer 418 is lower than that of the p++-InGaAs layer 419. The implantation dose of He⁺ is 2×10¹⁴ cm⁻² to 5×10¹⁵ cm⁻², for example, 3×¹⁴ cm⁻². The doping concentration of the p-InP layer 418 is relatively low. The implantation dose of He⁺ is less than 2×10¹⁴ cm⁻², for example, less than 1.5×10¹⁴ cm⁻².

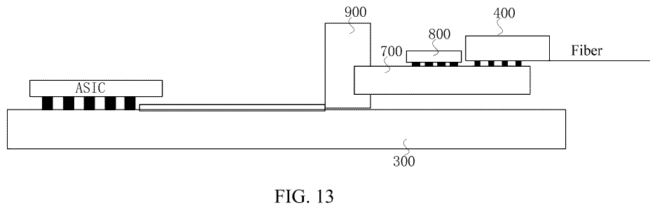

Based on the optical chip 400 provided in the above embodiments, the present embodiment provides a hybrid integrated optical assembly. FIG. 13 is a structural diagram of a hybrid integrated optical assembly according to some embodiments. As shown in FIG. 13, in some embodiments, the hybrid integrated optical assembly includes a substrate 700, a driver 800, and an optical chip 400. The driver 800 is disposed above the substrate 700. The optical chip 400 is disposed above the substrate 700 and optically connected to an optical fiber.

In some embodiments, the driver 800 may be connected to the substrate 700 via solder balls. The optical chip 400 may be connected to the substrate 700 via solder balls.

In some embodiments, the optical module 200 may include an electrical connection portion 900. One end of the optical assembly is embedded with and connected to the electrical connection portion 900. The electrical connection portion 900 is electrically connected to the circuit board 300. By way of example, one end of the electrical connection portion 900 is electrically connected to the driver 800. One end of the electrical connection portion 900 is electrically connected to the optical chip 400. The other end of the electrical connection portion 900 is electrically connected to an application-specific integrated circuit (ASIC) device via a high-frequency transmission line.

The optical chip 400 in the embodiments of the present disclosure may provide support for linear drive applications. The support facilitates ensuring the transmission quality of high-frequency signals, and allows long high-frequency transmission lines to transmit electrical signals to the optical chip 400.

The above descriptions are merely specific embodiments of the present disclosure, but the scope of protection of the present disclosure is not limited thereto. Any of those skilled in the art can think of changes or substitutions within the technical scope of the present disclosure, and these changes or substitutions shall all be included within the scope of protection of the present disclosure. Therefore, the scope of protection of the present disclosure shall be subject to the scope of protection of the claims.

1. An optical chip, comprising:
an electrode electrically connected to a radio frequency traveling waveguide;
a ridged waveguide comprising a first region and a second region located at a side of the first region, wherein the electrode is disposed above the first region, while the electrode is not disposed above the second region;
wherein the first region comprises, from top to bottom, an n++-InGaAs layer, a fourth n-InP layer, an i-InP layer, an i-InGaAsP layer and a quantum well layer; the second region comprises, from top to bottom, a fourth n-InP layer, an i-InP layer, an i-InGaAsP layer and a quantum well layer; there are no helium ions in the first region; there are helium ions in the fourth n-InP layer in the second region, and there are no helium ions in the i-InP layer and below the i-InP layer in the second region;
or,
the first region comprises, from top to bottom, a p++-InGaAs layer, a p-InP layer, an i-InP layer, an i-InGaAsP layer and a quantum well layer; the second region comprises, from top to bottom, a p-InP layer, an i-InP layer, an i-InGaAsP layer and a quantum well layer; there are no helium ions in the first region, and there are helium ions in the p-InP layer of the second region; there are no helium ions in the i-InP layer and below the i-InP layer in the second region.

2. The optical chip according to claim 1, wherein
in a case that the first region comprises, from top to bottom, the p++-InGaAs layer, the p-InP layer, the i-InP layer, the i-InGaAsP layer and the quantum well layer, the second region further comprises a p++-InGaAs layer disposed above the p-InP layer; and there are no helium ions in the p++-InGaAs layer and the p-InP layer in the second region.

3. The optical chip according to claim 1, wherein
in a case that the first region comprises, from top to bottom, the n++-InGaAs layer, the fourth n-InP layer, the i-InP layer, the i-InGaAsP layer and the quantum well layer, the second region further comprises an n++-InGaAs layer disposed above the fourth n-InP layer, and there are not helium ions in the n++-InGaAs layer and the fourth n-InP layer in the second region.

4. The optical chip according to claim 1, wherein the ridged waveguide comprises a first ridged waveguide and a second ridged waveguide, each of the first ridged waveguide and the second ridged waveguide comprising a plurality of first regions and a plurality of second regions, and the second regions being arranged at opposite ends of the first regions;
the electrode comprises a plurality of first electrodes and a plurality of second electrodes, the first electrodes being disposed above first regions of the first ridged waveguide, and the second electrodes being disposed above first regions of the second ridged waveguide.

5. The optical chip according to claim 4, wherein the radio frequency traveling waveguide comprises a first radio frequency traveling waveguide and a second radio frequency traveling waveguide, and wherein the first radio frequency traveling waveguide is located at one side of the first electrode, and the first electrode is electrically connected to the first radio frequency traveling waveguide; and the first radio frequency traveling waveguide is located at one side of the second electrode, and the second electrode is electrically connected to the second radio frequency traveling waveguide.

6. The optical chip according to claim 1, further comprising a Si waveguide, wherein the Si waveguide comprises an optical input end, a first Si waveguide, a second Si waveguide and an optical output end, and wherein
the optical input end is located at one end below the ridged waveguide, and the optical output end is located at another end below the ridged waveguide; one end of the first Si waveguide and one end of the second Si waveguide are respectively connected to the optical input end; and the other end of the first Si waveguide and the other end of the second Si waveguide are respectively connected to the optical output end.

7. The optical chip according to claim 6, wherein the optical chip further comprises a substrate layer, an intermediate layer and a cladding layer that are arranged in sequence from bottom to top, and wherein the Si waveguide is arranged in the cladding layer;
the optical chip further comprises a first n-InP layer, a first n-InGaAsP layer, a second n-InP layer, a second n-InGaAsP layer and a third n-InP layer that are arranged in sequence from bottom to top; the cladding layer supports and connects the first n-InP layer, and the third n-InP layer supports and connects the ridged waveguide.

8. The optical chip according to claim 7, wherein the ridged waveguide comprises an i-p-n-InAlAs layer disposed above the third n-InP layer, and wherein the i-p-n-InAlAs layer, the quantum well layer, the i-InGaAsP layer, the i-InP layer, the fourth n-InP layer and the n++-InGaAs layer form the ridged waveguide.

9. The optical chip according to claim 6, wherein the ridged waveguide, the Si waveguide and the electrode form an MZM modulator of a nipn epitaxial structure or an MZM modulator of a pin epitaxial structure.

10. The optical chip according to claim 6, further comprising a first heater, a second heater and a matching resistor, wherein the first heater is located above the first Si waveguide, the second heater is located above the second Si waveguide, and the first heater and the second heater are located at a side of one end of the radio frequency traveling waveguide; the matching resistor is located at a side of the other end of the radio frequency traveling waveguide and is electrically connected to the radio frequency traveling waveguide.

11. The optical chip according to claim 1, wherein the ridged waveguide comprises a passivation layer that is configured to protect a top portion of the optical chip.

12. A method of preparing an optical chip, comprising:
forming a ridged waveguide, the ridged waveguide comprising a first region and a second region, wherein the first region is configured to arrange an electrode thereon, the second region is located at opposite ends of the first region, and the electrode is not arranged above the second region, and wherein the first region comprises an n++-InGaAs layer, a fourth n-InP layer, an i-InP layer, an i-InGaAsP layer and a quantum well layer that are arranged from top to bottom, and the second region comprises an n++-InGaAs layer, a fourth n-InP layer, an i-InP layer, an i-InGaAsP layer and a quantum well layer that are arranged from top to bottom; or, the first region comprises a p++-InGaAs layer, a p-InP layer, an i-InP layer, an i-InGaAsP layer and a quantum well layer that are arranged from top to bottom, and the second region comprises a p++-InGaAs layer, a p-InP layer, an i-InP layer, an i-InGaAsP layer and a quantum well layer that are arranged from top to bottom;
covering the first region with a preset mask, and implanting helium ions into the second region in multiple times, wherein there are no helium ions in the first region; there are helium ions in the n++-InGaAs layer and the fourth n-InP layer in the second region, or in the p++-InGaAs layer and the p-InP layer in the second region; and there are no helium ions in the i-InP layer and below the i-InP layer in the second region; and
forming the electrode and a radio frequency traveling waveguide on a top of the first region, wherein the electrode is electrically connected to the radio frequency traveling waveguide.

13. The method according to claim 12, wherein the implanting helium ions into the second region in multiple times comprises:
implanting helium ions for a first time such that helium ions are implanted and stopped at a bottom of the n++-InGaAs layer in the second region;
implanting helium ions for a second time such that helium ions are implanted through a contact portion between the n++-InGaAs layer and the fourth n-InP layer in the second region; and
implanting helium ions for a third time such that helium ions are implanted and stopped at a bottom of the fourth n-InP layer in the second region.

14. The method according to claim 12, wherein the implanting helium ions into the second region in multiple times comprises:
implanting helium ions for a first time such that helium ions are implanted and stopped at a bottom of the p++-InGaAs layer in the second region;
implanting helium ions for a second time such that the helium ions are implanted through a contact portion between the p++-InGaAs layer and the p-InP layer in the second region; and
implanting helium ions for a third time such that helium ions are implanted and stopped at a bottom of the p-InP layer in the second region.

15. The method according to claim 12, wherein a helium ion doping concentration of the n++-InGaAs layer or the p++-InGaAs layer in the second region is higher than that in the fourth n-InP layer or the p-InP layer.

16. The method according to claim 15, wherein a dose of helium ions implanted into the second region is 1×10¹⁴ cm⁻² to 9×10¹⁴ cm⁻².

17. An optical module, comprising:
a circuit board;
an optical chip that is electrically connected to the circuit board and configured to modulate and generate an optical signal, wherein the optical chip comprises an electrode and a ridged waveguide, and wherein
the ridged waveguide comprises, from top to bottom, an n++-InGaAs layer, a fourth n-InP layer, an i-InP layer, an i-InGaAsP layer and a quantum well layer; or comprises, from top to bottom, a p++-InGaAs layer, a p-InP layer, an i-InP layer, an i-InGaAsP layer and a quantum well layer;
the ridged waveguide comprises a first region and a second region, wherein the second region is located at a side of the first region; the electrode is arranged above the first region, while the electrode is not arranged above the second region; there are no helium ions in the first region;
there are helium ions in the n++-InGaAs layer and the fourth n-InP layer in the second region, or there are helium ions in the p++-InGaAs layer and the p-InP layer in the second region, and there are no helium ions in the i-InP layer and below the i-InP layer in the second region.

18. The optical module according to claim 17, wherein the optical chip has an InP-based MZM modulator.

19. The optical module according to claim 17, wherein the optical chip is integrated with a light-emitting region which is configured to generate multiple beams of light.

20. The optical module according to claim 19, wherein the light-emitting region is grown from an InP material, and the light-emitting region comprises a grating layer.
